(19) United States
(12) Patent Application Publication
(10) Pub. No.: US 2020/0332938 A1
(43) Pub. Date: Oct. 22, 2020

(54) PIPELINE CONNECTION MECHANISM

(71) Applicant: WUYI University, Guangdong (CN)

(72) Inventor: Min Wu, Guangdong (CN)

(21) Appl. No.: 16/512,947

(22) Filed: Jul. 16, 2019

(30) Foreign Application Priority Data
Apr. 22, 2019 (CN) 201910323891.7

(51) Int. Cl. F16L 41/04; F16L 41/08

(52) U.S. Cl. CPC F16L 41/04; F16L 41/08

(57) ABSTRACT

The present disclosure discloses a pipeline connection mechanism. The pipeline connection mechanism includes a first pipe section, a second pipe section, a third pipe section and a punching mechanism; one end of the first pipe section is fixed on an original pipeline, and the other end of the first pipe section is detachably connected with the second pipe section; and the second pipe section is detachably connected with the third pipe section or the punching mechanism; the third pipe section communicates with an additional pipeline; and the punching mechanism passes through the first pipe section as well as the interior of the second pipe section, and punches the original pipeline. The additional pipeline may communicate with the original pipeline without changing a structure of the original pipeline, and thus the assembly is convenient.

### TECHNICAL FIELD

The present disclosure relates to the technical field of device installation, and in particular, to a pipeline connection mechanism.

### BACKGROUND

At present, in a large refrigeration device, a pipeline for delivering ammonia cannot be moved freely. However, if another pipeline needs to be added on an original pipeline to supply the ammonia to the rest systems, the arrangement of the pipeline still needs to be re-planned, which is inevitable to stop production and re-install the pipeline; and in such a case, the cost will be consumed greatly and the installation is inconvenient.

### SUMMARY

The present disclosure is intended to solve at least one of the above-mentioned technical problems in the related art to a certain extent. To this end, the present disclosure discloses a pipeline connection mechanism.

The technical solutions adopted by the present disclosure to solve the technical problems are as follows.

A pipeline connection mechanism includes: a first pipe section, configured to be fixedly connected with an original pipeline and communicate with the original pipeline, the first pipe section being detachably connected with a second pipe section; the second pipe section, including a first connecting end and a second connecting end, the first connecting end being detachably connected with the first pipe section, the second connecting end being connected with a third pipe section or a punching mechanism, a separation block being disposed between the first connecting end and the second connecting end, the separation block being disposed in an inner cavity of the second pipe section, and the separation block separating the inner cavity of the second pipe section; the third pipe section, configured to be fixedly connected with the original pipeline and communicate with the original pipeline, the third pipe section being detachably connected with the second pipe section; and the punching mechanism, connected with the second pipe section, and configured to pass through the first pipe section as well as the interior of the second pipe section, and punch the original pipeline, where the separation block is disposed in the inner cavity of the second pipe section horizontally, and the separation block is capable of stretching out and drawing back in the inner cavity of the second pipe section.

The punching mechanism includes: a fourth pipe section, including a third connecting end and a sealing end, the third connecting end being detachably connected with the second connecting end, and the sealing end being provided with a driller; and the driller, configured to punch the original pipeline, the driller being capable of stretching out and drawing back in the fourth pipe section, the second pipe section and the first pipe section.

The present disclosure has the following beneficial effects: when a pipeline is connected, the original pipeline is punched first by using the punching mechanism firstly, and then the original pipeline communicates with the additionally arranged pipeline via the second pipe section. Therefore, the additionally arranged pipeline may communicate with the original pipeline without changing a structure of the original pipeline, and thus the assembly is convenient.

### BRIEF DESCRIPTION OF DRAWINGS

The present disclosure will be further described below in conjunction with the accompanying drawings and embodiments.

FIG. 1 is a structural schematic diagram of the present disclosure in a drilling state;

FIG. 2 is a structural schematic diagram of the present disclosure upon the completion of installation; and

FIG. 3 is a structural schematic diagram of installation among a second pipe section, a separation block and clapboards.

### DESCRIPTION OF EMBODIMENTS

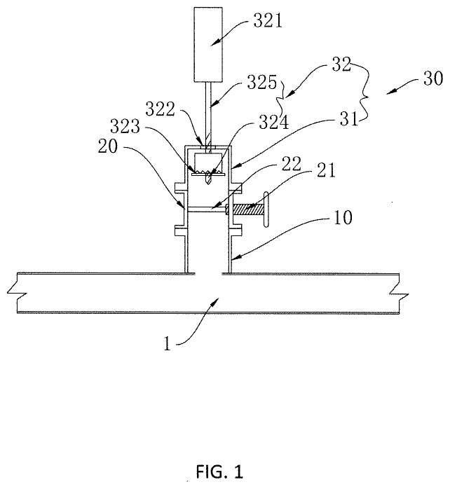

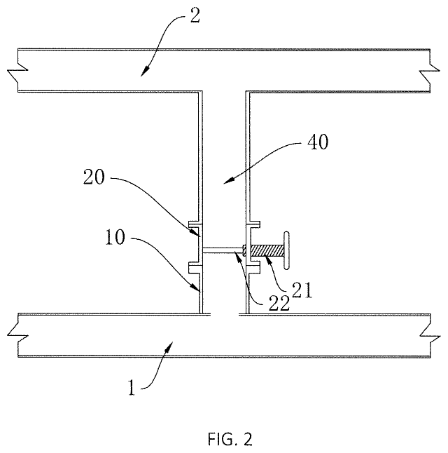

Referring to FIG. 1 to FIG. 3, a pipeline connection mechanism provided by the present disclosure includes: a first pipe section 10, configured to be fixedly connected with an original pipeline 1 and communicate with the original pipeline 1, the first pipe section 10 being detachably connected with a second pipe section 20; the second pipe section 20, including a first connecting end and a second connecting end, the first connecting end being detachably connected with the first pipe section 10, the second connecting end being connected with a third pipe section 40 or a punching mechanism 30, a separation block 21 being disposed between the first connecting end and the second connecting end, the separation block 21 being disposed in an inner cavity of the second pipe section 20, and the separation block 21 separating the inner cavity of the second pipe section 20; the third pipe section 40, configured to be fixedly connected with the original pipeline 1 and communicate with the original pipeline 1, the third pipe section 40 being detachably connected with the second pipe section 20; and the punching mechanism 30, connected with the second pipe section 20, and configured to pass through the first pipe section 10 as well as the interior of the second pipe section 20, and punch the original pipeline 1, where the separation block 21 is disposed in the inner cavity of the second pipe section 20 horizontally, and the separation block 21 is capable of stretching out and drawing back in the inner cavity of the second pipe section 20.

According to the present disclosure, when a pipeline is connected, the original pipeline 1 is punched first by using the punching mechanism 30, and then the original pipeline 1 communicates with the additional pipeline 2 via the second pipe section 20. Therefore, the additional pipeline may communicate with the original pipeline 1 without changing a structure of the original pipeline 1, and thus the assembly is convenient.

In actual use, the first pipe section 10 is fixed on a surface of the original pipeline 1 first via an installation manner such as welding, and screw sealing and fixing. It is to be noted that an opening of the first pipe section 10 matches a surface shape of the original pipeline 1 to form sealing. Thereafter, the second pipe section 20 is installed on the first pipe section 10 and the punching mechanism 30 is installed on the second pipe section 20, and the original pipeline 1 is punched by using the punching mechanism 30. In some embodiments, the punching mechanism 30 includes: a fourth pipe section 31, including a third connecting end and a sealing end, the third connecting end being detachably connected with the second connecting end, and the sealing end being provided with a driller 32; and the driller 32, configured to punch the original pipeline 1, the driller 32 being capable of stretching out and drawing back in the fourth pipe section 31, the second pipe section 20 and the first pipe section 10. By enabling the driller 32 to stretch out and draw back in the fourth pipe section 31, the driller 32 passes through the second pipe section 20 and the first pipe section 10, abuts against the surface of the original pipeline 1 and drills through the original pipeline 1, so that the original pipeline 1 communicates with the first pipe section 10 and the second pipe section 20. Upon the completion of punching, the driller 32 is returned to the fourth pipe section 31; and the separation block 21 is used to separate a space of the second pipe section 20, so that the fourth pipe section 31 does not communicate with the first pipe section 10; and then, the punching mechanism 30 is detached, and the third pipe section 40 is installed; and since the third pipe section 40 is fixedly connected with the additionally arranged pipeline 2 and communicates with the additionally arranged pipeline 2, the installation of the additional pipeline 2 on the original pipeline 1 is implemented.

It is to be noted that the original pipeline 1 refers to a pipeline device that is installed already and is in use, and the additionally arranged pipeline 2 refers to a new pipeline required to be added to the original pipeline device. The additionally arranged pipeline may communicate with the original pipeline 1 without changing a structure of the original pipeline 1, and thus the assembly is convenient.

In some embodiments, the driller 32 includes a telescopic rod 325 and a drill bit 324; the telescopic rod 325 is inserted into the sealing end and is capable of sliding in the sealing end; the drill bit 324 is disposed on an end portion of the telescopic rod 325; and a sealing ring 322 is disposed at a place where the telescopic rod 325 abuts against the sealing end. In actual use, the telescopic rod 325 slides on the sealing end, so that the drill bit 324 moves in the fourth pipe section 31, the second pipe section 20 and the first pipe section 10. When the drill bit 324 moves to a lower end to abut against an outer wall of the original pipeline 1, the drill bit 324 starts to drill the original pipeline 1. Upon the completion of drilling, the drill bit 324 is driven by the telescopic rod 325 to return to the fourth pipe section 31. At this moment, a material in the original pipeline 1 overflows from a hole. When the separation block 21 separates the space inside the second pipeline, a part of the material easily overflows into the fourth pipe section 31, and thus with the arrangement of the sealing ring 322, the fourth pipe section 31 can be effectively prevented from overflowing the material to an external environment.

In some embodiments, a sealing ring 322 is disposed at a place where the fourth pipe section 31 abuts against the drill bit 324. After drilling, the ammonia enters the first pipe section 10 from the hole and enters the fourth pipe section 31 along the second pipe section 20. Gas leakage easily occurs at the connection place where the drill bit 324 is inserted into the fourth pipe section 31 and causes ammonia leakage, and thus with the arrangement of the sealing ring 322, ammonia leakage is effectively prevented during drilling.

In some embodiments, the separation block 21 is inserted into the interior of the second pipe section 20 from an exterior of the second pipe section 20; the interior of the second pipe section 20 is provided with two clapboards 22; a gap is formed between the two clapboards 22; the separation block 21 is capable of being embedded into the gap and sliding in the gap; and the separation block 21 stretches into the second pipe section 20 and abuts against an inner wall of the second pipe section 20 to separate a space in the second pipe section 20. It is to be noted that a width of the gap is greater than a width of the drill bit 324; when there is a need for drilling, the drill bit 324 passes through the gap to reach the original pipeline 1; and upon the completion of drilling, the separation block 21 slides in the gap and is cooperated with the two clapboards 22 to separate the space inside the second pipe section 20, thus preventing the leakage when the third pipe section 40 is switched to be connected.

In some embodiments, a baffle plate 323 is disposed at a place where the drill bit 324 is connected with the telescopic rod 325; and an area of the baffle plate 323 is greater than an area of a maximum cross section of the drill bit 324. When the drill bit 324 drills the original pipeline 1, the material easily overflows in the drilling process; and with the utilization of the baffle plate 323, the material may be effectively prevented from entering the first pipe section 10 massively. As a preferable implementation, a shape of the baffle plate 323 matches a shape of the inner cavity of the first pipe section 10.

Preferably, in this embodiment, the detachable connection is respectively implemented between the first pipe section 10 and the second pipe section 20, the second pipe section 20 and the third pipe section 40 as well as the second pipe section 20 and the fourth pipe section 31 via flange connection. In addition, the detachable connection may further be implemented via manners such as buckling.

In some embodiments, one end, far away from the drill bit 324, of the telescopic rod 325 is provided with a cylinder 321; and the cylinder 321 is configured to drive the telescopic rod 325 to stretch out and draw back in the fourth pipe section 31, the second pipe section 20 and the first pipe section 10.

In some embodiments, a through hole is formed on an outer wall of the second pipe section 20; the separation block 21 is inserted from the through hole and is capable of sliding in the through hole; the interior of the second pipe section 20 is provided with two clapboards 22; a gap is formed between the two clapboards 22; the separation block 21 is capable of being embedded into the gap and sliding in the gap; and the separation block 21 stretches into the second pipe section 20 and abuts against an inner wall of the second pipe section 20 to separate a space in the second pipe section 20.

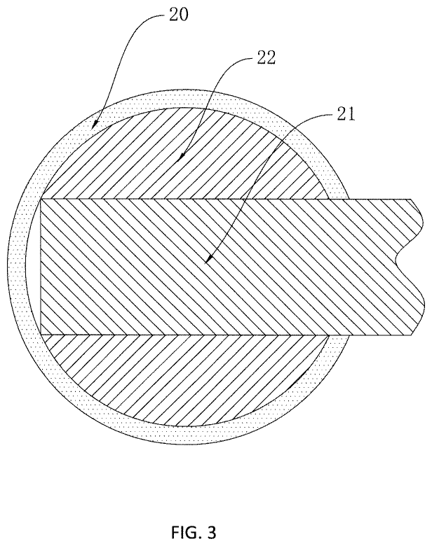

Referring to FIG. 3, when the drill bit 324 is returned to the fourth pipe section 31, the separation block 21 stretches into the gap, and is cooperated with the clapboards 22 to separate the second pipe section 20 into two spaces. The separation block 21 may be configured as a plate shape or a screw. In this embodiment, only the screw is selected, since the gap between the screw and the arc second pipeline is very small and does not affect the barrier effect.

The above specific structures and dimensional data are specific descriptions on preferred embodiments of the present disclosure. However, the present disclosure is not limited to the above embodiments. Those skilled in the art may further make various equivalent variations or replacements without departing from the spirit of the present disclosure, and these equivalent variations or replacements all are included in a scope defined by the claims of the present application.

What is claimed is:

1. A pipeline connection mechanism, comprising:
a first pipe section, configured to be fixedly connected with an original pipeline and communicate with the original pipeline, the first pipe section being detachably connected with a second pipe section;
the second pipe section, comprising a first connecting end and a second connecting end, the first connecting end being detachably connected with the first pipe section, the second connecting end being connected with a third pipe section or a punching mechanism, a separation block being disposed between the first connecting end and the second connecting end, the separation block being disposed in an inner cavity of the second pipe section, and the separation block separating the inner cavity of the second pipe section;
the third pipe section, configured to be fixedly connected with the original pipeline and communicate with the original pipeline, the third pipe section being detachably connected with the second pipe section; and
the punching mechanism, connected with the second pipe section, and configured to pass through the first pipe section as well as the interior of the second pipe section, and punch the original pipeline;
wherein the separation block is disposed in the inner cavity of the second pipe section horizontally, and the separation block is capable of stretching out and drawing back in the inner cavity of the second pipe section.

2. The pipeline connection mechanism according to claim 1, wherein the punching mechanism comprises:
a fourth pipe section, comprising a third connecting end and a sealing end, the third connecting end being detachably connected with the second connecting end, and the sealing end being provided with a driller; and
the driller, configured to punch the original pipeline, the driller being capable of stretching out and drawing back in the fourth pipe section, the second pipe section and the first pipe section.

3. The pipeline connection mechanism according to claim 2, wherein the driller comprises a telescopic rod and a drill bit; the telescopic rod is inserted into the sealing end and is capable of sliding in the sealing end; the drill bit is disposed on an end portion of the telescopic rod; and a sealing ring is disposed at a place where the telescopic rod abuts against the sealing end.

4. The pipeline connection mechanism according to claim 3, wherein a baffle plate is disposed at a place where the drill bit is connected with the telescopic rod; and an area of the baffle plate is greater than an area of a maximum cross section of the drill bit.

5. The pipeline connection mechanism according to claim 3, wherein one end, far away from the drill bit, of the telescopic rod is provided with a cylinder; and the cylinder is configured to drive the telescopic rod to stretch out and draw back in the fourth pipe section, the second pipe section and the first pipe section.

6. The pipeline connection mechanism according to claim 1, wherein a through hole is formed on an outer wall of the second pipe section; the separation block is inserted from the through hole and is capable of sliding in the through hole; the interior of the second pipe section is provided with two clapboards; a gap is formed between the two clapboards; the separation block is capable of being embedded into the gap and sliding in the gap; and the separation block stretches into the second pipe section and abuts against an inner wall of the second pipe section to separate a space in the second pipe section.

7. The pipeline connection mechanism according to claim 6, wherein the separation block comprises a screw.
